(19) United States
(12) Patent Application Publication
(10) Pub. No.: US 2013/0087494 A1
(43) Pub. Date: Apr. 11, 2013

(54) FLUID FILTERING APPARATUS AND METHOD OF MAKING SAME

(71) Applicants: David Jay Taubenslag, Monmouth Junction, NJ (US); Christopher Scott Rau, Battle Creek, MI (US)

(72) Inventors: David Jay Taubenslag, Monmouth Junction, NJ (US); Christopher Scott Rau, Battle Creek, MI (US)

(73) Assignee: Eaton Corporation

(21) Appl. No.: 13/253,325

(22) Filed: Oct. 5, 2011

(51) Int. Cl. B01D 29/00; B23P 11/00; B23K 31/02; B01D 24/00

(52) U.S. Cl. 210/282; 210/416.1; 29/428; 228/164

(57) ABSTRACT

A pressurized fluid filtering vessel of the type having a rigid porous container which may be a basket filled with filtering material has a barrier disposed in the outlet such that, in the event of structural failure of the container, particles of the container are prevented from entering the outlet of the pressure vessel. In one version, the barrier comprises a grid and in another version, the barrier comprises a perforated plate.

### BACKGROUND

The present disclosure relates to filtering fluids in a system having pressurized fluid flowing therethrough and particularly systems where the fluid is circulated in a closed system. Systems employing pressurized fluid such as hydraulic fluid or water may require filtering to remove foreign matter and debris which may accumulate in the system over time and in prolonged service. In providing filtering of such fluid systems, it has been found particularly convenient and economical to provide a pressure vessel with a removable filter element or filtering material employed in a basket which may be accessible for removal and replacement. The filtering element may have the form of a rigid porous container which may be filled with particulate filtering material or may comprise a filter bag or even a combination thereof or permanent removable straining elements such as perforated screen metal mesh or slotted wedge wire formed into a removable basket for providing the desired level of filtration. The pressure vessel is typically provided with a closure or lid which is releasable for enabling access to the interior of the vessel to permit removal and replacement of the filtering material or filter bag.

Where the filtering apparatus is employed for high volume flow or in systems where relatively high fluid pressure is employed, a significant pressure differential may occur across the filtering material or bag, upon containment of a significant amount of trapped material and clogging in the filter. This pressure differential may result in forces causing catastrophic structural failure of the basket resulting in fragments and debris entering the vessel outlet and the fluid system.

Where failure of the filter basket has been experienced, entry of loose metal fragments of the basket into the outlet of the vessel, and thus the fluid system, can result in significant damage to the fluid operating system and to the pumps employed for the fluid. Failures of this type can be particularly catastrophic in hydraulic fluid systems such as those employed for operating high volume flow cooling circuits in industrial plants, power generation applications and ships.

Thus, it has been desired to provide a way or means of protecting a fluid filtering apparatus from discharging metal fragments or other debris into the fluid system in the event of catastrophic structural failure within the filtering apparatus.

### SUMMARY

The present disclosure describes a fluid filtering apparatus having a pressure vessel defining a fluid chamber with an inlet and outlet communicating with the chamber. Fluid filtering material is disposed with a rigid porous container or basket which is disposed in the fluid pressure chamber. The basket may contain filtering material such as granular material or may be employed in conjunction with a filter bag. A porous barrier is provided in the outlet of the pressure vessel to contain and prevent entry into the outlet of fragments of the basket in the event of catastrophic structural failure of the basket. The barrier, in one version disclosed, comprises a metal mesh or plurality of spaced rods disposed in a grid and may be attached in the vessel outlet by suitable fasteners or weldment. In another disclosed version, the barrier has the form of a perforated plate and may have a ratio of open to closed area of about 2:1. The barrier is configured to provide the desired fluid flow yet is sufficiently robust to retain any loose fragments of the basket in the event of such failure.

### BRIEF DESCRIPTION OF THE DRAWINGS

FIG. 1 is an elevation view of the pressure vessel employing the filter and containment member of the present disclosure;

FIG. 2 is a cross-sectional view of FIG. 1;

FIG. 3 is a perspective view of one version of the containment barrier of the apparatus in the present disclosure; and,

FIG. 4 is a view similar to FIG. 3 of another version of the containment barrier of the present disclosure.

### DETAILED DESCRIPTION

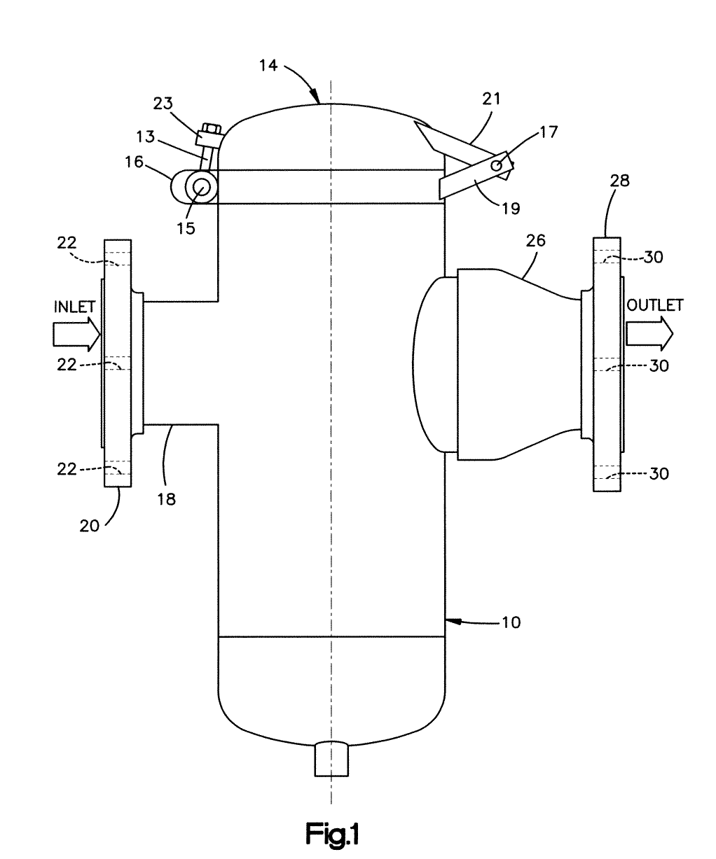

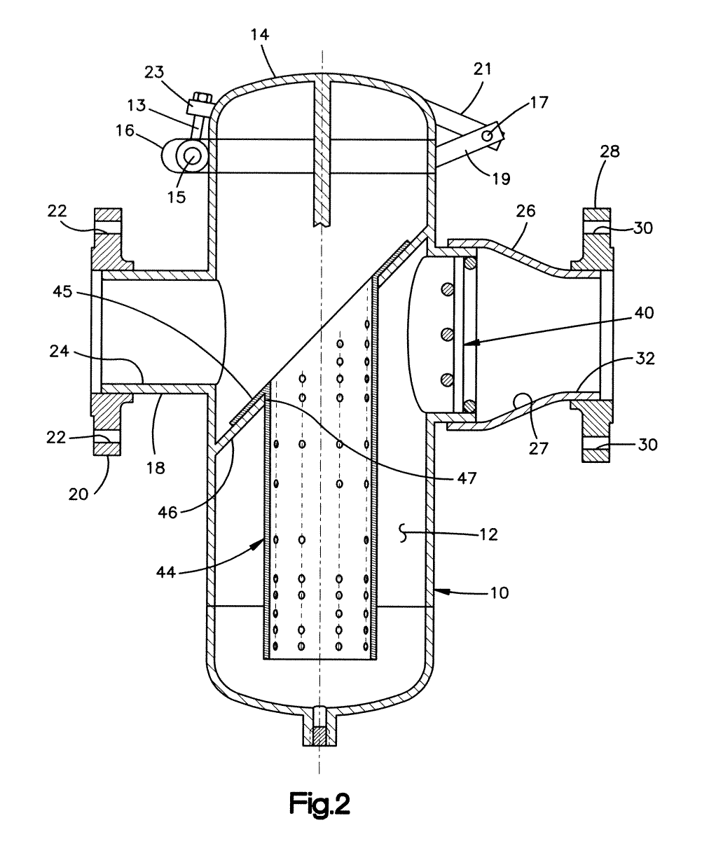

Referring to FIGS. 1 and 2, a pressure vessel indicated generally at 10 is illustrated as having a generally hollow cylindrical configuration with the upper end thereof open and the lower end thereof closed in a somewhat domed configuration and the vessel thus forms therein a pressure chamber 12 with lid 14 which is shown in a closed position in FIG. 1.

The lid 14 may be secured by fasteners such as swing bolts 13 pivotally attached via a pin 15 through apertures in attachment lugs 16 disposed about the open end of the vessel 10 and engaging a lug 23 on the lid 14. Additional lugs such as lug 19 may be provided on the open end of vessel 10 for pivotal mounting thereto of the lid by lug 21 provided on lid 14 and pivotal pin 17 if desired.

The pressure vessel has an outlet boss or standoff 18 formed on the side wall thereof with an attachment flange 20 provided thereabout for connection to a fluid pressure conduit (not shown). The flange 20 has a plurality of fastener apertures 22 formed therethrough and spaced circumferentially thereabout for enabling the attachment to the fluid pressure system. The boss 18 is provided with a passage or port 24 (see FIG. 2) which communicates with the interior of the pressure chamber 12 as will be hereinafter described. In the present disclosure, the port 24 is the inlet port for the pressure chamber 12.

Disposed circumferentially spaced from the boss 18 is an outlet boss 26 which has a circular attachment flange 28 provided thereon with circumferentially spaced apertures 30 provided on the flange for enabling attachment to a conduit (not shown) for supplying filtered pressurized fluid thereto. The boss 26 has provided therein an outlet passage or port 32 which communicates with the interior of the pressure chamber 12. The diameter of the interface between the vessel shell 10 and the boss 26 is larger than that of the outlet through the flange 28. The transition between the larger flow, inlet diameter and the smaller flow outlet diameter 32 is accomplished through a concentric or eccentric reducer 27.

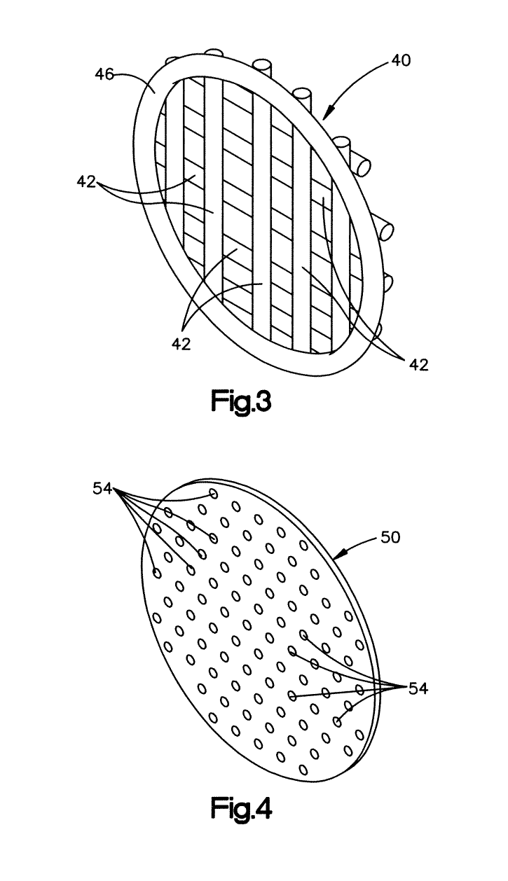

Referring to FIGS. 2 and 3, a containment barrier indicated generally at 40 is shown in one version in the form of a mesh or grid of wire members or rods 42 welded in an open grid manner to permit flow of fluid to the outlet passages 32. The rods or bars 42 which form the barrier 40 may be pre-formed as a welded grid and subsequently welded into the outlet passage 32. Referring to FIG. 3, the containment barrier 40 is illustrated in the prefabricated form with a circumferential ring 46 provided thereon to facilitate installation within the outlet port 32. Alternatively the rods 42 may be individually welded into the passage.

Referring to FIG. 2, a porous rigid filtering container shown in the form of a removable basket 44 is disposed in the pressure chamber 12; and, the basket 44 may contain additional desired filtering material. In the present practice the basket indicated generally at 44 may be constructed of a porous permanent filtering media of coarse retention; however, alternatively, a filter bag may be employed in connection with the basket 44.

The open end of the basket is sealed about its periphery through an aperture provided in a bulkhead or interior wall 46 provided in pressure chamber 12 which isolates the basket such that only the upper end thereof communicates with inlet passage 24; and thus, all fluid entering the inlet port 24 flows through the filtering material associated with the basket 44 before exiting to outlet port 32. If desired, the open end of the basket may have an outwardly extending flange 45 provided about the open end thereof for providing sealing about the aperture 47 in wall 46.

Referring to FIG. 4, an alternative version of the containment barrier is indicated generally at 50 and comprises a plate 52 having a plurality of spaced apertures 54 formed therethrough to permit the desired fluid flow yet prevent passage of fragmentary metal which would be deleterious to the system employing the filter. In the present practice, it has been found satisfactory to form the plate 52 as having the ratio of open area of the apertures to the closed areas of the plate in the range of no less than 2 to 1.

It will be understood that in either version of the containment barrier 40 of FIG. 3 or 50 of FIG. 4, the barrier must be sufficiently robust to withstand the forces of fragments of the basket in the event of catastrophic structural failure of the filter basket. In the present practice, the version 40 has the bars or rods formed of wire having a diameter of about 0.1875″ to 0.5″ (4.7 mm-12.2 mm) with an open area spacing of about one fourth (¼) to one sixth (⅙) of the inlet diameter of boss 26. In practice this relates to spacing between 0.5″ to 3″ (12.2 mm-76 mm) between between adjacent rods. In the version 50 of FIG. 4, the containment barrier plate has a thickness of about 0.6 to 1.6 mm and a plurality of apertures, each having a diameter of about 4 mm with at least 50% of the surface area of the plate being open for flow. In the present practice, one version of a pressure vessel employed with either barrier 40 or 50 has an inlet diameter to boss 26 of sufficient diameter to result in an open area at the throat of the boss of at least 50% greater cross-sectional area than that of the inlet side boss 18. This additional surface area is offset by the reduction in flowable area caused by either version 40 or version 50 of the porous barrier plates. The containment barrier of the present disclosure may be employed with filtering systems employing vessels of different dimensions than those of the illustrated versions.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A fluid filtering apparatus comprising:
a. a vessel defining a fluid pressure chamber having an inlet and outlet adapted for connection thereto to receive fluid flow therethrough;
b. a rigid porous filtering container and having an open end disposed for communicating exclusively with the pressure chamber inlet; and
c. a containment barrier disposed in the pressure chamber outlet and operative for permitting fluid flow and for preventing debris of a certain size from entering the outlet.

2. The apparatus defined in claim 1 wherein the containment barrier includes a rigid plate having a plurality of spaced apertures therein.

3. The apparatus defined in claim 2 wherein the apertures comprise an open/closed area ratio of about 2:1.

4. The apparatus defined in claim 1, wherein the containment barrier includes a metal plate secured to the pressure vessel outlet by weldment.

5. The apparatus defined in claim 1, wherein the containment barrier is sufficiently robust that, upon structural failure of the rigid porous container, any resultant fragments of the container are prevented from entering the pressure vessel outlet.

6. The apparatus defined in claim 1, wherein the containment barrier is formed of one of a metal grid and metal mesh.

7. The apparatus defined in claim 1, wherein the filtering material includes one of granular material and a filter bag.

8. The apparatus defined in claim 1, wherein the filtering container includes removable filtering material

9. The apparatus defined in claim 1, wherein the pressure vessel includes a removable lid forming a portion of the pressure chamber.

10. The apparatus defined in claim 1, wherein the rigid porous container comprises a metal basket.

11. The apparatus defined in claim 1, wherein the pressure vessel includes a removable lid forming a portion of the pressure chamber and the rigid porous container is removable from the vessel upon removal of this lid.

12. A method of making a fluid filtering apparatus comprising:
a. forming a pressure vessel having an inlet and outlet;
b. forming a porous filtering container with an open end;
c. disposing the container in the pressure vessel and communicating the open end exclusively with the vessel inlet; and,
d. disposing a containment barrier in the vessel outlet and permitting fluid flow therethrough and in the event of structural failure of the basket, preventing passage of any fragments of the basket into the outlet.

13. The method defined in claim 12, wherein the step of disposing a containment barrier includes securing a porous plate.

14. The method defined in claim 13, wherein the step of disposing a porous plate includes disposing a plate having and open to closed area ratio of about 2:1.

15. The method defined in claim 12, wherein the step of disposing a containment barrier includes securing a porous plate by weldment.

16. The method defined in claim 12, wherein the step of forming a pressure vessel includes providing a removable lid.

17. The method defined in claim 12, wherein the step of disposing a filtering container includes disposing a basket and disposing filtering material with the basket.

18. The method defined in claim 17, wherein the step of disposing filtering material with the basket includes disposing a filter bag in the basket.

19. The method defined in claim 17, wherein the step of disposing filtering material includes disposing granular material in the basket.
